(19) United States
(12) Patent Application Publication
(10) Pub. No.: US 2016/0282983 A1
(43) Pub. Date: Sep. 29, 2016

(54) TOUCH DISPLAY APPARATUS AND TOUCH PANEL THEREOF

(71) Applicant: InnoLux Corporation, Miao-Li County (TW)

(72) Inventors: Chia-Hsiung CHANG, Miao-Li County (TW); Yang-Chen CHEN, Miao-Li County (TW); Chao-Hsiang WANG, Miao-Li County (TW)

(21) Appl. No.: 14/796,010

(22) Filed: Jul. 10, 2015

(30) Foreign Application Priority Data
Mar. 27, 2015 (TW) 104109927

(51) Int. Cl. G06F 3/044

(52) U.S. Cl. CPC G06F 3/044

(57) ABSTRACT

A touch display apparatus and a touch panel thereof are provided. The touch panel includes a substrate, a plurality of inductive electrodes, and at least one bridge part. The inductive electrodes are arranged on the substrate along a first direction and are spaced apart from each other. The bridge part electrically connects two adjacent inductive electrodes, wherein the bridge part has a first edge, a second edge, and a third edge between the first edge and the second edge. The extension line of the first edge, the extension line of the second edge, and the third edge form a first region having an area larger than zero.

### CROSS REFERENCE TO RELATED APPLICATIONS

The present application claims priority of Taiwan Patent Application No. 104109927, filed on Mar. 27, 2015, the entirety of which is incorporated by reference herein.

### BACKGROUND OF THE INVENTION

1. Field of the Invention

The present application relates to a touch technology, and in particular to a touch display apparatus and a touch panel thereof.

2. Description of the Related Art

In recent years, touch display apparatuses have come to be widely used in various electronic products, such as mobile phones, personal digital assistants (PDA), and handheld PCs. A touch display apparatus generally includes a touch panel and a display panel, and the touch panel is attached to the display panel. A user can touch images shown on the touch display apparatus to input messages or operate electronic product.

Typically, a touch panel has a touch electrode layer for generating sensing signals, and then the sensing signals are analyzed by, for example, a processor to calculate and determine the actual touch positions. The touch electrode layer usually includes stacked sensing electrodes and bridge parts. When the sensing electrodes have difficulty covering the bridge parts, electrical performance and process yield of the touch electrode layer may be adversely affected, thus reducing the reliability of the whole touch panel. What is needed, therefore, is a touch panel (structure) which can overcome the problems described above.

### BRIEF SUMMARY OF THE INVENTION

An embodiment of the invention provides a touch panel, including a substrate, a plurality of first inductive electrodes, and at least one bridge part. The first inductive electrodes are arranged on the substrate along a first direction and are spaced apart from each other. The bridge part electrically connects two adjacent first inductive electrodes, wherein the bridge part has a first edge, a second edge, and a third edge between the first edge and the second edge. The extension line of the first edge, the extension line of the second edge, and the third edge form a first region having an area larger than zero.

In another embodiment, the third edge is connected with the first edge at a first point and is connected with the second edge at a second point, wherein the extension line of the first edge is extended along the first direction from the first point, and the extension line of the second edge is extended along a second direction from the second point.

In another embodiment, the extension line of the first edge is substantially parallel to the first direction, and the extension line of the second edge is substantially parallel to the second direction.

In another embodiment, the third edge is a straight line, a concave curved line, or a convex curved line.

In another embodiment, a side-wall of the bridge part corresponding to the third edge forms an inclined surface.

In another embodiment, the touch panel further includes a plurality of second inductive electrodes, at least one second bridge part, and at least one insulation part. The second inductive electrodes are arranged on the substrate along the second direction and are spaced apart from each other. The second bridge part electrically connects two adjacent second inductive electrodes, wherein the second bridge part and the bridge part are formed in an intersected manner. The insulation part is arranged between the second bridge part and the bridge part for electrically isolating the first inductive electrodes and the second inductive electrodes.

In another embodiment, the thickness of the bridge part is greater than that of the first inductive electrodes and greater than that of the second inductive electrodes.

In another embodiment, the touch panel further includes at least one buffering part arranged on the bridge part, the insulation part, and the second bridge part.

In another embodiment, the buffering part has a first edge along a third direction, a second edge along a fourth direction, and a third edge between the first edge and the second edge (of the buffering part). The third direction is different from the fourth direction. The extension line of the first edge of the buffering part, the extension line of the second edge of the buffering part, and the third edge of the buffering part form a second region have an area larger than zero.

Another embodiment of the invention also provides a touch display apparatus, including the touch panel described above and a display panel attached to the touch panel.

In another embodiment, the substrate of the touch panel is a tempered glass substrate.

In another embodiment, the substrate has a first surface and a second surface opposite to the first surface, wherein the first inductive electrodes are formed on the first surface and face the display panel, and the second surface is a touch surface.

In another embodiment, the touch display apparatus further includes a tempered glass substrate, and the substrate of the touch panel has a first surface and a second surface opposite to the first surface. The first inductive electrodes are formed on the first surface and face the tempered glass substrate, and the display panel is attached to the second surface.

In another embodiment, the substrate of the touch panel is a color filter substrate or an array substrate.

In order to illustrate the purposes, features and advantages of the invention, the preferred embodiments and figures of the invention are shown in detail as follows.

### BRIEF DESCRIPTION OF THE DRAWINGS

The invention can be more fully understood by reading the subsequent detailed description and examples with references made to the accompanying drawings, wherein:

FIG. 1 is a schematic top view of (a part of) a touch panel according to an embodiment of the invention;

FIG. 2 is a cross-sectional view taken along line A-A′ in FIG. 1;

FIG. 3A is an enlarged view of part B in FIG. 1, and FIGS. 3B and 3C are enlarged views of part B in some other embodiments of the invention;

FIG. 4 is a cross-sectional view taken along line C-C′ in FIG. 3A;

FIG. 5 is an enlarged view of part D in FIG. 1; and

FIGS. 6A and 6B are schematic views showing configurations of different touch display apparatuses according to some embodiments of the invention.

### DETAILED DESCRIPTION OF THE INVENTION

In the following detailed description, the orientations of “on”, “over”, “under” and “below” are used for representing the relationship between the relative positions of each element as illustrated in the drawings, and are not used to limit the invention. Moreover, the formation of a first material layer over or on a second material layer in the description that follows may include embodiments in which the first and second material layers are formed in direct contact, or the first and second material layers have one or more additional material layers formed therebetween.

In addition, the present disclosure may repeat reference numerals and/or letters in the various examples. This repetition is for the purpose of simplicity and clarity and does not in itself dictate a relationship between the various embodiments and/or configurations discussed. Moreover, some elements not shown or described in the embodiments have the forms known by persons skilled in the field of the invention.

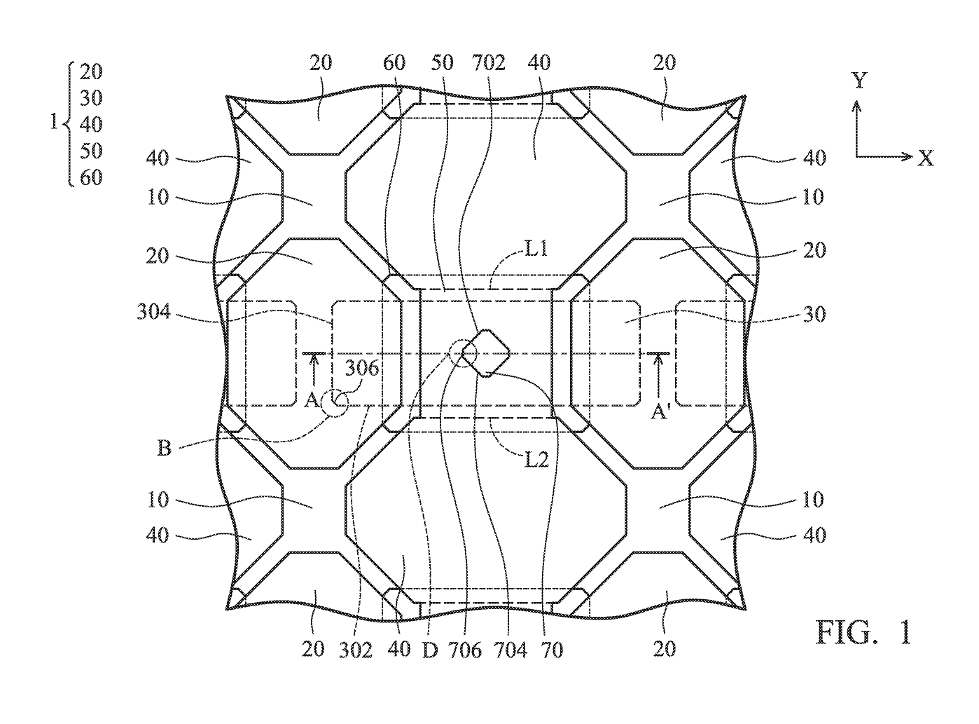

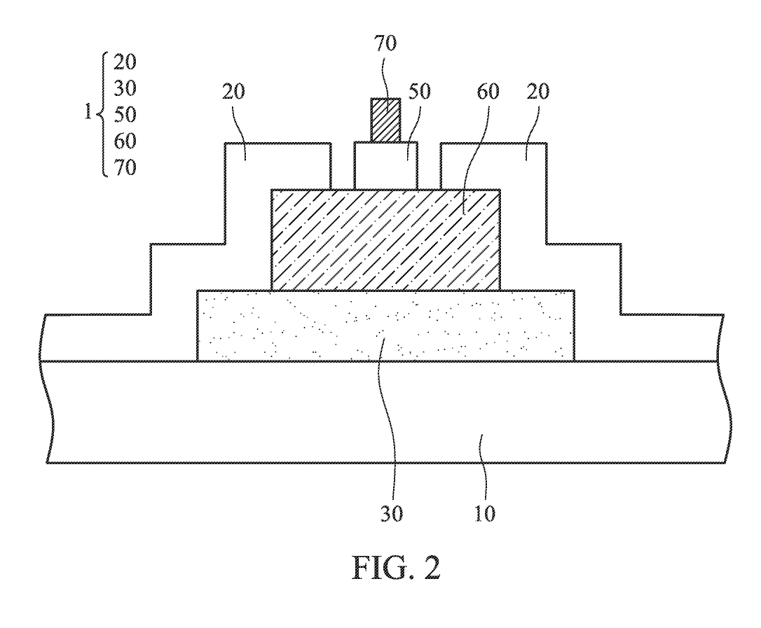

FIG. 1 is a schematic top view of (a part of) a touch panel according to an embodiment of the invention. FIG. 2 is a cross-sectional view taken along line A-A′ in FIG. 1. Referring to FIG. 1 and FIG. 2, a touch panel in an embodiment of the invention primarily includes a substrate 10 and a touch electrode layer 1 formed on the substrate 10.

The touch electrode layer 1 includes a plurality of first inductive electrodes 20 and a plurality of second inductive electrodes 40. The first inductive electrodes 20 are arranged along the X-direction (first direction) and are spaced apart from each other, and the second inductive electrodes 40 are arranged along the Y-direction (second direction) and are spaced apart from each other, wherein the X-direction is different from the Y-direction (e.g. they are perpendicular to each other). It should be understood that the first inductive electrodes 20 and the second inductive electrodes 40 shown in FIG. 1 are octangles, but they may also be triangles, diamonds, rectangles, hexagons, or other applicable shapes. Moreover, the inductive electrodes 20 and 40 shown in FIG. 1 can form a self-capacitance touch-sensing electrode structure, wherein each first inductive electrode 20 receives a driving signal and sends a sensing signal back to a processor (not shown), and each second inductive electrode 40 also receives a driving signal and sends a sensing signal back to the touch detection unit (the processor), individually. Under another touch detection operation, the inductive electrodes 20 and 40 shown in FIG. 1 can also form a mutual-capacitance touch-sensing electrode structure, wherein one of the inductive electrodes 20 and 40 is a driving electrode for receiving the driving signal, and the other is a sensing electrode for sending the sensing signal back to the processor.

The touch electrode layer 1 further includes a plurality of bridge parts 30, a plurality of second bridge parts 50, and a plurality of insulation parts 60. The bridge part 30 is configured to electrically connect two adjacent first inductive electrodes 20 along the X-direction, and the second bridge part 50 is configured to electrically connect two adjacent second inductive electrodes 40 along the Y-direction. As shown in FIG. 1 and FIG. 2, the first inductive electrode 20 of this embodiment covers a part of the bridge part 30 (the edges of the bridge parts 30 underneath the first inductive electrodes 20 are shown in dashed lines in FIG. 1). Thus, two adjacent first inductive electrodes 20 electrically connect to each other via the bridge part 30. Moreover, the bridge part 30 and the second bridge part 50 are formed in an intersected manner. In this embodiment, the second bridge part 50 is arranged on the bridge part 30. Furthermore, the insulation part 60 is arranged between the bridge part 30 and the second bridge part 50 for isolating them, so that the first inductive electrodes 20 and the second inductive electrodes 40 are electrically isolated from each other and not shorted. The second bridge part 50 above the bridge part 30 may be a bridge structure. Note that, preferably, the second bridge parts 50 and the second inductive electrodes 40 are formed at the same time, and thus the range of the second bridge part 50 is between the two dashed lines L1 and L2 shown in FIG. 1.

Accordingly, the touch electrode layer 1 forms an electrode array for generating sensing signals, and the sensing signals can be sent back, via a wiring layer (not shown), to the back-end processor to calculate and determine the actual touch positions.

In addition, the substrate 10 can be an organic or an inorganic substrate, wherein the organic substrate may be formed of a plastic material, and the inorganic substrate may be formed of a glass material. In some embodiments, the substrate 10 can be used simultaneously as a protective cover for the component layers in the touch panel and a carrier substrate of the touch electrode layer 1. In another alternative embodiment, the substrate 10 may also be a color filter substrate or an array substrate. As the substrate 10 is chosen as a color filter substrate, the touch electrode layer 1 can be selectively formed on a surface of the color filter substrate facing or away from the user. Moreover, the first inductive electrodes 20, the second inductive electrodes 40, the bridge parts 30, and the second bridge parts 40 may comprise metal or transparent conductive material, and the insulation parts 60 may comprise organic insulating material, epoxy resin, polyimide, or methyl methacrylate (MMA).

The fabrication processes of the touch electrode layer 1 are illustrated as follows. In reality, any conventional process can be used to form the touch electrode layer 1. Referring to FIG. 1 and FIG. 2, for example, the touch electrode layer 1 is formed by forming a plurality of patterned bridge parts 30 on the substrate 10 by deposition, photolithography, and etching processes, firstly. Next, after the plurality of patterned insulation parts 60 are correspondingly formed on the bridge parts 30, the plurality of first inductive electrodes 20 arranged along the X-direction and the plurality of second inductive electrodes 40 and the second bridge parts 50 arranged along the Y-direction are simultaneously formed on the substrate 10, the bridge parts 30, and the insulation parts 60.

In this embodiment, the thickness of the bridge parts 30 is about 600 Å (angstroms) to 4000 Å, and the thickness of the first inductive electrodes 20, the second inductive electrodes 40, and the second bridge parts 50 is about 150 Å to 1500 Å. Preferably, the thickness of the bridge parts 30 is about 1.2 times to 15 times more than the thickness of the first inductive electrodes 20, the second inductive electrodes 40, and the second bridge parts 50.

In particular, each of the bridge parts 30 in this embodiment has four chamfered corners (FIG. 1). Accordingly, it is easier for the first inductive electrodes 20 to cover the bridge parts 30 entirely, thus preventing the first inductive electrodes 20 from being broken or the contact resistance from being increased. Conversely, when four corners of the bridge parts 30 are sharp or at right angles (as in the traditional design), the first inductive electrodes 20 are less likely to cover the bridge parts 30 entirely. Consequently, the first inductive electrodes 20 are prone to ruptures or the contact resistance can increase, resulting in the electrical performance (i.e. the touch-sensing capability) of the touch electrode layer 1 being adversely affected. Thus, the bridge parts 30 of this embodiment having four chamfered corners can facilitate great coverage of the first inductive electrodes 20 on the bridge parts 30 and reduce the point discharge, so as to improve the reliability of the touch electrode layer 1.

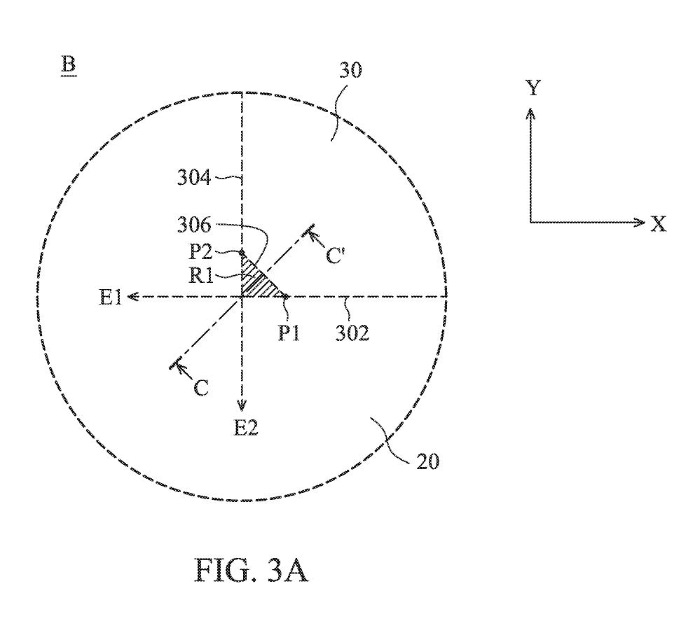

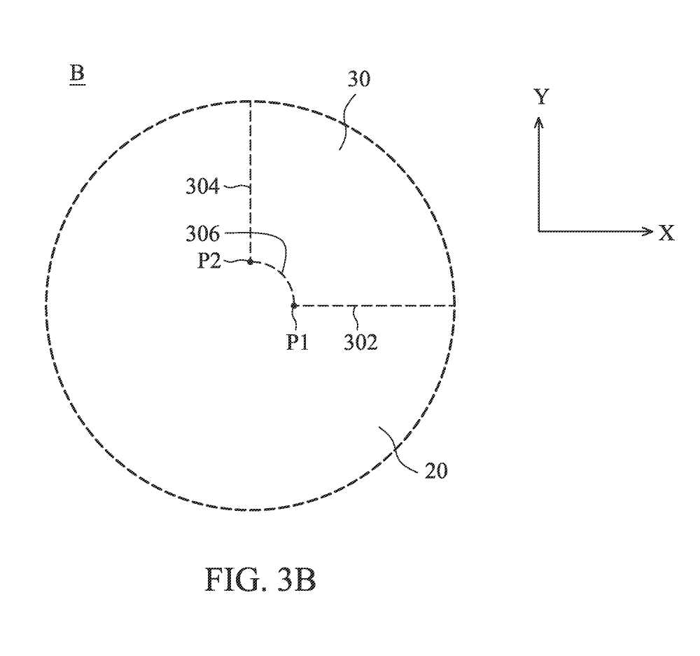

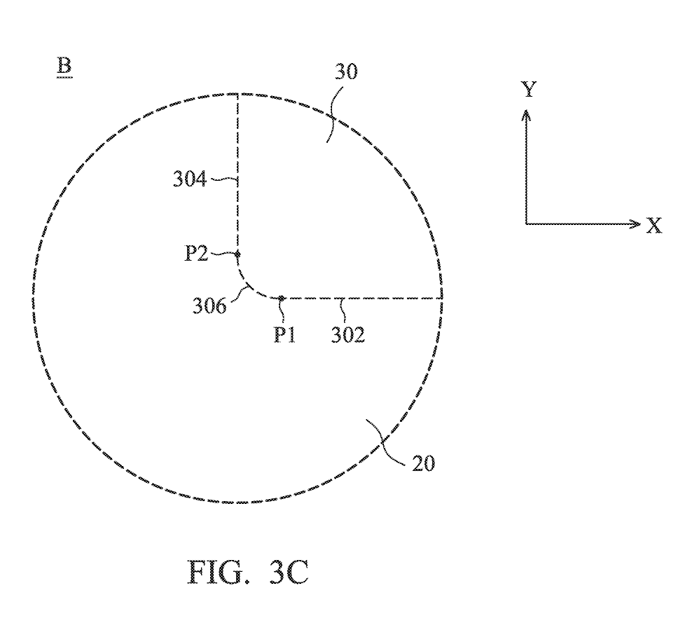

FIG. 3A is an enlarged view of part B in FIG. 1. As shown in FIG. 3A, the bridge part 30 has a first edge 302 along a direction such as the X-direction (but not limited thereto), a second edge 304 along a direction such as the Y-direction (but not limited thereto), and a third edge 306 between the first edge 302 and the second edge 304. Specifically, the third edge 306 is connected with the first edge 302 at a first point P1 and is connected with the second edge 304 at a second point P2. Moreover, an extension line E1 of the first edge 302 is extended along the X-direction from the first point P1, and an extension line E2 of the second edge 304 is extended along the Y-direction from the second point P2. Furthermore, the extension line E1 of the first edge 302 is substantially parallel to the X-direction, and the extension line E2 of the second edge 304 is substantially parallel to the Y-direction. Accordingly, the extension line E1 of the first edge 302, the extension line E2 of the second edge 304, and the third edge 306 form a first region R1 having an area larger than zero, thus achieving the four-chamfered-corner design of the bridge part 30. Although the third edge 306 shown in FIG. 3A is a straight line, it may also be a concave curved line (FIG. 3B) or a convex curved line (FIG. 3C).

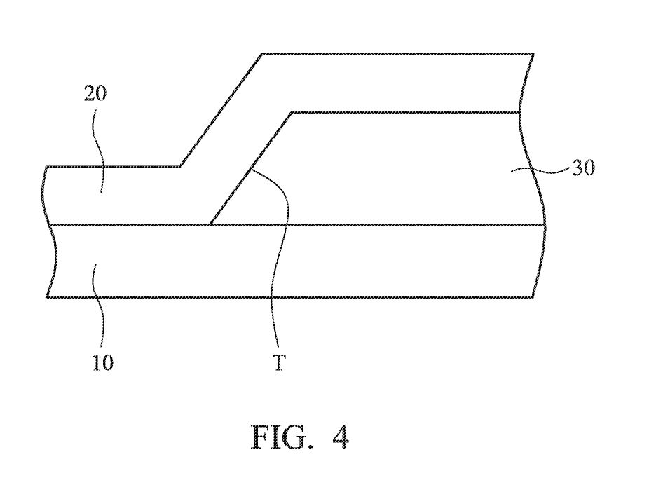

Moreover, in this embodiment, the side-walls of the bridge part 30 corresponding to the first edge 302, the second edge 304, and the third edge 306 (FIG. 4, a cross-sectional view taken along line C-C′ in FIG. 3A) form several inclined surfaces T. Thus, the first inductive electrodes 20 can also more easily cover the bridge parts 30 entirely.

Referring to FIG. 1 and FIG. 2, the touch panel of this embodiment further includes a buffering part 70, such as an organic material coating, arranged on the bridge part 30, the insulation part 60, and the second bridge part 50 of the touch electrode layer 1. The buffering part 70 can help to prevent the touch electrode layer 1 from being damaged in the process.

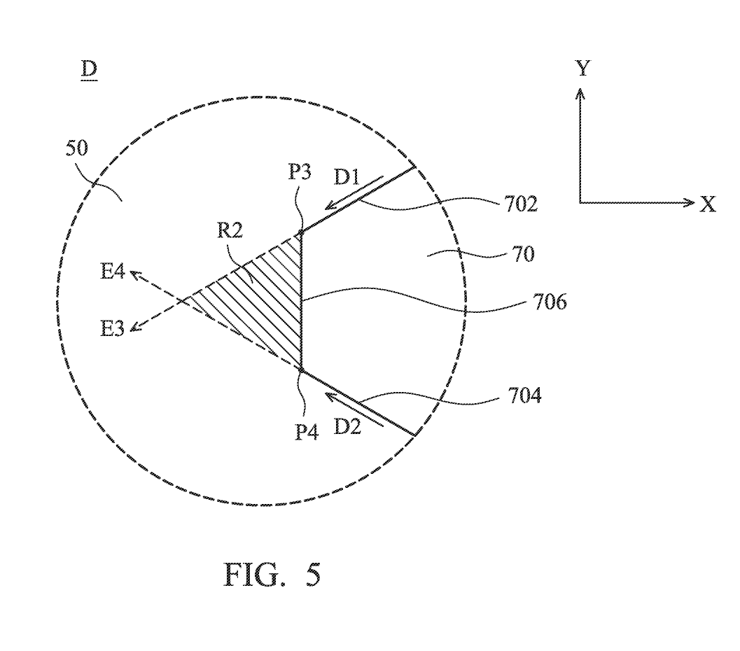

Similarly, the buffering part 70 also has four chamfered corners. FIG. 5 is an enlarged view of part D in FIG. 1. As shown in FIG. 5, the buffering part 70 has a first edge 702 along a third direction D1 (different from the X-direction and Y-direction), a second edge 704 along a fourth direction D2 (different from the X-direction and Y-direction), and a third edge 706 between the first edge 702 and the second edge 704, wherein the third direction D1 is different from the fourth direction D2. The third edge 706 is connected with the first edge 702 at a third point P3 and is connected with the second edge 704 at a fourth point P4. Moreover, an extension line E3 of the first edge 702 is extended along the third direction D1 from the third point P3, and an extension line E4 of the second edge 704 is extended along the fourth direction D2 from the fourth point P4. Furthermore, the extension line E3 of the first edge 702 is substantially parallel to the third direction D1, and the extension line E4 of the second edge 704 is substantially parallel to the fourth direction D2. Accordingly, the extension line E3 of the first edge 702, the extension line E4 of the second edge 704, and the third edge 706 form a second region R2 having an area larger than zero, thus achieving the four-chamfered-corner design of the buffering part 70.

It should be realized that, after the buffering part 70 is formed on the bridge part 30, the insulation part 60, and the second bridge part 50 of the touch electrode layer 1, a transparent adhesive layer may be provided on the buffering part 70 and another part such as display panel is then attached to the touch panel, so as to complete assembly of the touch display apparatus. Therefore, the four-chamfered-corner design of the buffering part 70 can also facilitate great coverage (entire coverage) of the transparent adhesive layer on the buffering part 70 and prevent air bubbles from being formed in the gap between the transparent adhesive layer and the buffering part 70. Consequently, the optical performance of the touch panel can also be improved.

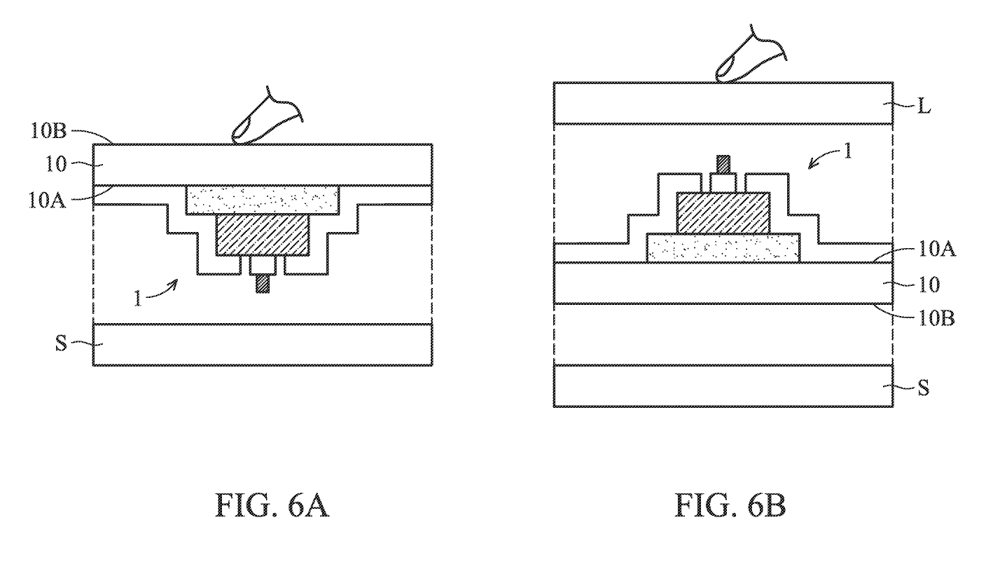

FIGS. 6A and 6B are schematic views showing configurations of different touch display apparatuses according to some embodiments of the invention.

In the embodiment of FIG. 6A, the touch display apparatus primarily includes the touch panel as described above and a display panel S. The substrate 10 of the touch panel is a tempered glass substrate that is scratch-resistant, protects the touch electrode layer 1, and is decorative. Specifically, the substrate 10 has a first surface 10A and a second surface 10B opposite to the first surface 10A. The touch electrode layer 1 (including the first and second inductive electrodes) is formed on the first surface 10A and faces the display panel S. The second surface 10B is a touch surface for touch operation using fingers or a stylus. In this embodiment, the substrate 10 can be used simultaneously as a protective cover for the component layers in the touch panel and a carrier substrate of the touch electrode layer 1. In FIG. 6A, a transparent adhesive layer configured to bond the touch panel and the display panel S is omitted.

In the embodiment of FIG. 6B, the touch display apparatus primarily includes a tempered glass substrate L, the touch panel as described above, and a display panel S. The substrate 10 of the touch panel has a first surface 10A and a second surface 10B opposite to the first surface 10A. The touch electrode layer 1 (including the first and second inductive electrodes) is formed on the first surface 10A and faces the tempered glass substrate L. The display panel S is attached to the second surface 10B. In this embodiment, the tempered glass substrate L provides a touch surface for protecting the touch panel and the display panel S. In FIG. 6B, several transparent adhesive layers configured to bond the tempered glass substrate L, the touch panel, and the display panel S are omitted.

It should be understood that, in the above embodiments, only the bridge part 30 and the buffering part 70 have a four-chamfered-corner design, but the second bridge part 50 and the insulation part 60 may also be designed to have four chamfered corners. Thus, the material layers used in the subsequent processes can be entirely covered on the second bridge part 50 and the insulation part 60, so as to improve the process yield and reliability of the whole touch panel.

As described above, the invention provides a touch display apparatus and a touch panel thereof. The touch panel includes a substrate, a plurality of inductive electrodes, and at least one bridge part. The inductive electrodes are arranged on the substrate along a first direction and are spaced apart from each other. The bridge part electrically connects two adjacent inductive electrodes, wherein the bridge part has a first edge along the first direction, a second edge along a second direction, and a third edge between the first edge and the second edge, the second direction being different from the first direction. The extension line of the first edge, the extension line of the second edge, and the third edge form a first region having an area larger than zero. With the above structural design (the chamfered-corner design), the known problems wherein the inductive electrodes have difficulty covering the bridge parts can be overcome, and thus the electrical performance and process yield of the touch electrode layer can be improved. Consequently, the reliability of the whole touch panel is effectively increased.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising:
a substrate;
a plurality of first inductive electrodes, arranged on the substrate along a first direction and spaced apart from each other; and
at least one bridge part, electrically connecting two adjacent first inductive electrodes, wherein the bridge part has a first edge, a second edge, and a third edge between the first edge and the second edge, wherein the extension line of the first edge, the extension line of the second edge, and the third edge form a first region having an area larger than zero.

2. The touch panel as claimed in claim 1, wherein the third edge is connected with the first edge at a first point and is connected with the second edge at a second point, wherein the extension line of the first edge is extended along the first direction from the first point, and the extension line of the second edge is extended along a second direction from the second point.

3. The touch panel as claimed in claim 2, wherein the extension line of the first edge is substantially parallel to the first direction, and the extension line of the second edge is substantially parallel to the second direction.

4. The touch panel as claimed in claim 1, wherein the third edge is a straight line, a concave curved line, or a convex curved line.

5. The touch panel as claimed in claim 1, wherein a side-wall of the bridge part corresponding to the third edge forms an inclined surface.

6. The touch panel as claimed in claim 1, further comprising a plurality of second inductive electrodes, at least one second bridge part, and at least one insulation part, the second inductive electrodes arranged on the substrate along the second direction and spaced apart from each other, the second bridge part electrically connecting two adjacent second inductive electrodes, wherein the second bridge part and the bridge part are formed in a intersected manner, and the insulation part is arranged between the second bridge part and the bridge part for electrically isolating the first inductive electrodes and the second inductive electrodes.

7. The touch panel as claimed in claim 6, wherein a thickness of the bridge part is greater than that of the first inductive electrodes and greater than that of the second inductive electrodes.

8. The touch panel as claimed in claim 6, further comprising at least one buffering part arranged on the bridge part, the insulation part, and the second bridge part.

9. The touch panel as claimed in claim 8, wherein the buffering part has a first edge along a third direction, a second edge along a fourth direction, and a third edge between the first edge and the second edge of the buffering part, the third direction different from the fourth direction, wherein the extension line of the first edge of the buffering part, the extension line of the second edge of the buffering part, and the third edge of the buffering part form a second region having an area larger than zero.

10. A touch display apparatus, comprising:
the touch panel as claimed in claim 1; and
a display panel, attached to the touch panel.

11. The touch display apparatus as claimed in claim 10, wherein the substrate of the touch panel is a tempered glass substrate.

12. The touch display apparatus as claimed in claim 11, wherein the substrate has a first surface and a second surface opposite to the first surface, the first inductive electrodes formed on the first surface and facing the display panel, and the second surface is a touch surface.

13. The touch display apparatus as claimed in claim 10, further comprising a tempered glass substrate, and the substrate of the touch panel has a first surface and a second surface opposite to the first surface, the first inductive electrodes formed on the first surface and facing the tempered glass substrate, and the display panel is attached to the second surface.

14. The touch display apparatus as claimed in claim 10, wherein the substrate of the touch panel is a color filter substrate or an array substrate.
